(19) United States
(12) Patent Application Publication
(10) Pub. No.: US 2010/0188925 A1
(43) Pub. Date: Jul. 29, 2010

(54) Mixer Truck

(75) Inventors: Andreas Hüber, Leutkirch (DE); Martin Wittig, Biberach (DE)

Correspondence Address: DILWORTH & BARRESE, LLP, 1000 WOODBURY ROAD, SUITE 405, WOODBURY, NY, 11797, US

(73) Assignee: LIEBHERR-MISCHTECHNIK GMBH, Bad Schussenried (DE)

(21) Appl. No.: 12/694,420

(22) Filed: Jan. 27, 2010

(30) Foreign Application Priority Data
Jan. 28, 2009 (DE) UM 202009001045.7

(51) Int. Cl. B28C 5/06

(52) U.S. Cl. 366/30

(57) ABSTRACT

The present invention relates to a mixer truck with a water system and a water pump for generating the required water pressure in the water system and with further energy consumers, wherein the water pump and/or at least one further load is driven by an electric motor.

This invention relates to a mixer truck with a water system and a water pump for generating the required water pressure in the water system and with further energy consumers.

Energy consumers or briefly loads, which are mounted on the mixer truck, also are referred to as additional loads. Beside the water system, the same include for example the chute adjustment, the drum closure, an additive pump for providing additives which change the property of the concrete, and further electric loads, such as a camera, working lights or the like. The greatest load is the water system. On the one hand, it serves to clean the mixer truck after use and on the other hand to improve the flowability of the mix material. It can also serve to process the dry mix material to concrete. As a standard, a 500 I or 650 I water tank is provided, respectively, which can be filled via corresponding pipe conduits. The tank usually is mounted on the mixer truck transmission by means of a bracket. FIG. 1, which represents the prior art, schematically shows such construction. Via a main conduit 11, which is mounted on the outside of the frame, a water tank 9 is connected with an injection nozzle, which protrudes into the drum of the mixer truck via a rising pipe which optionally includes a water meter 14 and a dirt trap 12. A further connection for a cleaning tube 16 extends downwards from the manifold on the main conduit 11. In a manner not shown in the drawing, a second injection tube can also be arranged above the inlet funnel.

There exist different variants of operating the water system.

FIG. 1 shows a pneumatic water system, in which the pressure is generated via the compressed air supply on the truck. For this purpose, a pressure tank 1 is arranged on the truck. The compressed air is withdrawn from the compressed air supply of the underframe. Via protection and safety valves, such as the four-circuit protection valve 2 and the overflow valve 3, the systems of the truck, such as the brake system, are secured. These systems have priority. The air requirements of the secondary loads must be checked, in order to avoid damages of the pressure components, such as the compressor and the air drier. Via a pressure reducing valve 4 and a manometer 6, the required operating pressure is adjusted. In addition, a safety valve 7 and a test port 8 are provided. Reference numeral 10 designates two ball-type gate valves for filling the water tank 9. Finally, ball-type gate valves 13 and 15 are provided, in order to activate the cleaning tube 16 or the injection nozzle in the drum, respectively.

In another variant not shown in FIG. 1 the water system is operated via a water pump which is driven via the transmission of the mixer drum. For this purpose, the mixer transmission has an additional connecting flange laterally of the main flange. A centrifugal pump is mounted to the same. Here, the water tank is not configured as a pressure tank. It is disadvantageous that the pump only delivers when the drum rotates. The delivery volume is dependent on the rotational speed of the drum. It should be noted that the pump must not be operated with recycling water or water with additives. In addition, the pump should not run dry either. If there is a risk of frost, the water system must always be evacuated, wherein the ball-type gate valves 10 of FIG. 1 must be opened.

For operating the water system, the water pump can also be switchable hydraulically. Then, a gear pump is flanged to the mixer truck pump with through drive, which drives the hydraulic motor. This motor feeds the water pump. The drive only is dependent on the rotational speed of the drive motor of the truck, usually a diesel engine. Due to a valve block, this drive can be switched separately. An expansion of the hydraulic circuit is necessary for this variant. Here as well, the water system must be dewatered, if there is a risk of frost.

Another drive option consists in that the water pump is driven by a separate motor via a V-belt drive. The pump here is mounted on a tension station. In this case, however, the delivery rate is dependent on the rotational speed of the motor. All the aforementioned drive variants exhibit considerable disadvantages as regards the space requirement or the dependence on other operating systems of the mixer truck, so that considerable restrictions exist during operation of the energy consumers.

It is the object of the invention to develop a mixer truck such that possible energy consumers of the mixer truck can be used largely independently and corresponding to the requirements.

In accordance with the invention, this object is solved by the combination of the features of claim 1. In a mixer truck with a water system and a water pump for generating the required water pressure in the water system and with further energy consumers, the water pump and/or at least one further load therefore are driven by an electric motor.

This aspect of the invention has a number of advantages as compared to the systems represented above. First of all, the pressure tank can be omitted as compared to the solution used in accordance with the prior art as shown in FIG. 1. The water tank no longer must be arranged at a specific point of the mixer truck. On the one hand, rather, its shape can be chosen freely, so that it can be adapted to disturbing contours of the truck chassis. Since gravity no longer is of importance in the water tank, the same can be arranged at a low point of the chassis, so that the center of gravity of the entire mixer truck can be arranged at a lower level. In particular, the driving properties of the mixer truck and the driving safety also are improved thereby. In the mixer truck configured in accordance with the invention, a plastic tank can be used and the water conduits can be shortened in general.

Further advantageous aspects of the invention can be taken from the sub-claims following the main claim.

Accordingly, the drive energy of the electric motor can be provided via the on- board power supply of the mixer truck.

In accordance with a further aspect of the invention, the drive energy of the electric motor can be providable via an additionally mounted power source.

Finally, a generator can also serve as power source, which is driven via the truck drive, i.e. in general the diesel engine.

Furthermore, it is particularly advantageous to arrange a controller between the electric motor or the electric motors and the power source. As further loads, a high-pressure cleaner and/or a linear drive and/or a drum closure and/or a chute adjustment and/or an additive pump preferably can be provided.

In particular the chute adjustment and the drum closure can be driven via an active chain of electric motor and hydraulic drive.

Further details and advantages of the invention will be explained with reference to an embodiment illustrated in the drawing, in which:

FIG. 1: shows a schematic representation of a water system of a mixer truck in accordance with the prior art,

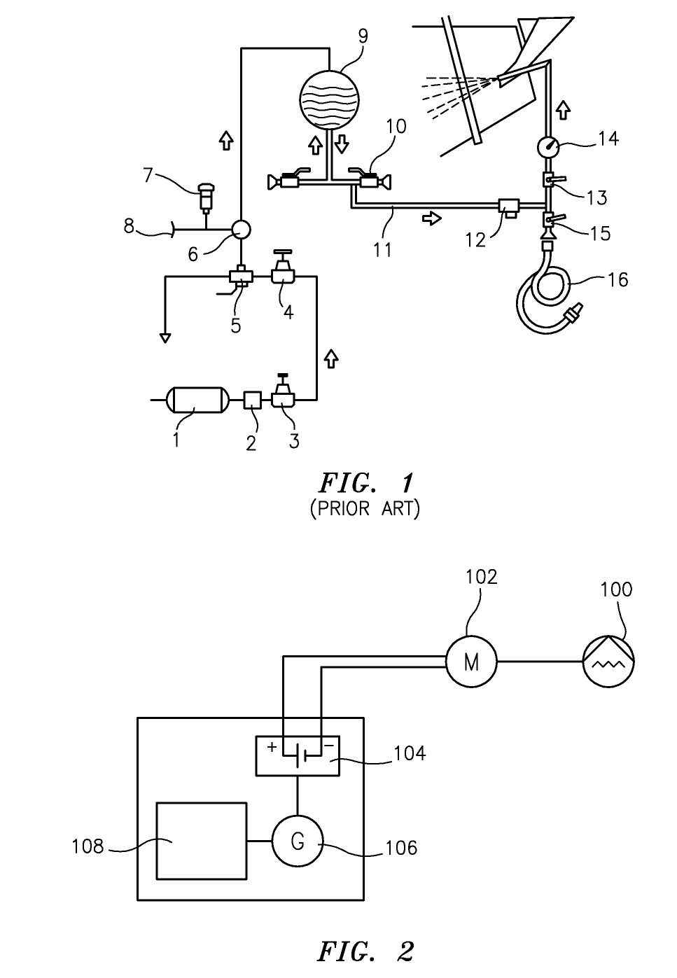

FIG. 2: shows a schematic representation of a part of the water system in accodance with a first variant of the present invention, and

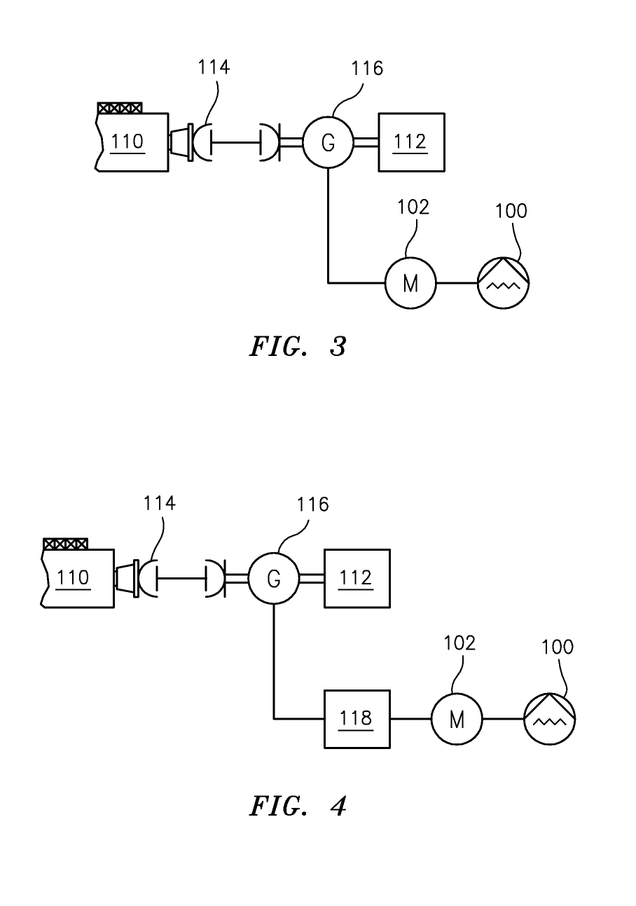

FIGS. 3-6: show further schematic representations of other embodiments of the invention.

In FIG. 2, a first variant of the invention is shown, wherein here only one circuit detail is shown. Thus, reference numeral 100 designates a water pump, by means of which water can be taken from a water tank arranged at point which is not illustrated here in detail, but can be arranged at any desired point of the mixer truck, and can be supplied to a likewise non-illustrated water nozzle or some other load, such as a water tube. The water pump is driven directly by an electric motor. In accordance with the variant shown in FIG. 2, the electric motor is fed from the on-board power supply of the underframe of the mixer truck not illustrated here in greater detail. There is shown a battery 104, which is fed via a generator 106. The generator 106 is driven by the diesel engine 108, which serves to drive the mixer truck. In the variant shown here, the diesel engine 108 serves both for propulsion of the mixer truck and for driving the drum.

In FIG. 3, a modified variant is shown, in which for the drum drive, which here is schematically designated with 112, a separate drive 110 is provided. Via an articulated shaft 114, the same is coupled with the generator 116 feeding the drum drive 112. To the generator, the electric motor 102 also is connected, which in turn drives the water pump 100.

A further modified variant of the invention can be taken from the representation as shown in FIG. 4. The separate drive 110 likewise is coupled with a generator 116 via an articulated shaft 114. The generator drives the drum drive 112 and the electric motor 102, which in turn supplies the water pump 100 with electrical energy. Upstream of the electric motor 102, however, a controller 118 is provided, which controls the supply of the electrical energy from the generator.

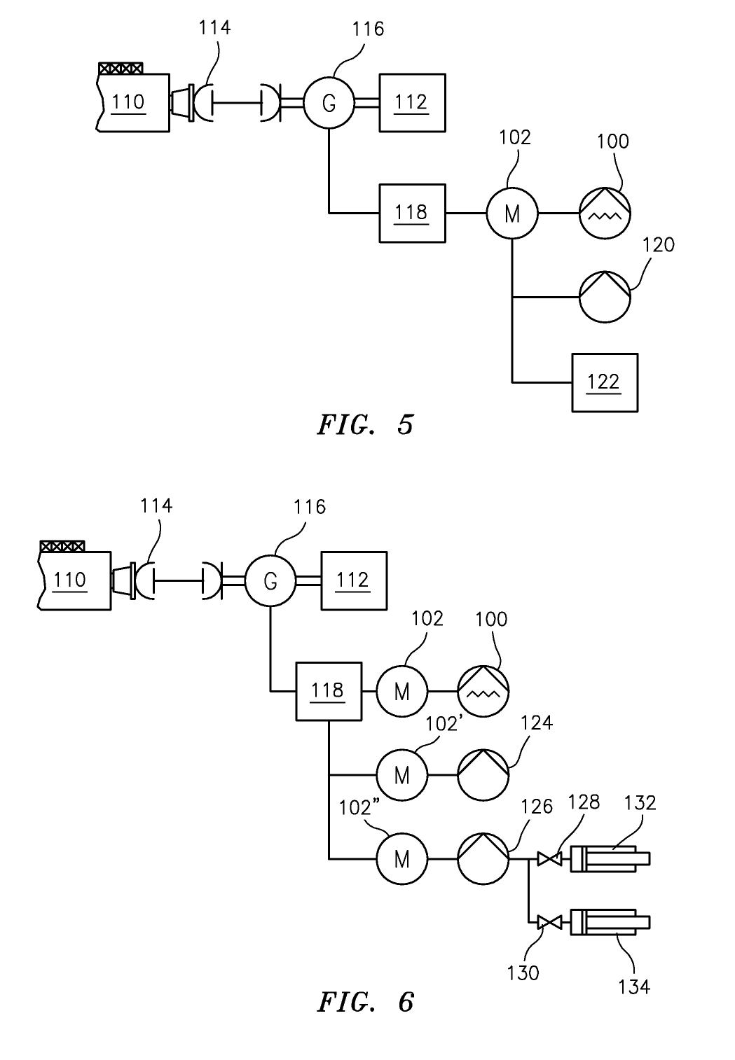

Beside the water system, further loads can also be provided, as is shown for example in FIGS. 5 and 6. In the variant as shown in FIG. 5, a separate drive 110 first of all likewise is coupled with a generator 116 via an articulated shaft 114. The generator initially serves to supply the drum drive 112 and via a controller 118 furthermore is coupled with an electric motor 102 which in turn drives a water pump 100. To the electric motor 102, a high-pressure cleaner additionally is connected, which is provided for cleaning the mixer truck. In the high-pressure cleaner a water pressure of up to 140 bar is achieved with 15 I/min, wherein for cleaning purposes the water usually is retrieved at a pressure of 80 bar to 100 bar, since at this pressure it will show the best cleaning effect. In the variant as shown in FIG. 5, a corresponding pump 120, which serves to pump the water supplied to the high-pressure cleaner, can be connected with the electric motor.

Furthermore, a linear drive 122 selectively can be connected with the electric motor. In the embodiment as shown in FIG. 5, various loads 100, 120 and 122 thus can selectively be driven simultaneously or separately by one single electric motor 102.

On the other hand, FIG. 6 shows a version similar to the aspect as shown in FIG. 5, in which a generator 116 likewise is driven again via a drive 110 and an articulated shaft 114, which generator serves to supply the drum drive 112 with electrical energy. Here as well, the generator 116 is connected with a plurality of loads via one controller 118. In the embodiment as shown in FIG. 6, a water pump 100 of the otherwise not illustrated water system is driven as a first load via its own electric motor 102. The two further loads, whose meaning will briefly be explained below, each are driven via their own electric motors 102′ and 102″. The load which is driven via its own electric motor 102′ is an additive pump 124. The additives are agents which are admixed to the concrete, in order to influence its behavior. In the prior art, they have been injected into the mixing drum by means of a pressurized tank or due to gravity. In the variant shown here, they are delivered by the electrically driven additive pump 124.

Finally, the electric motor 102″ drives a hydraulic pump 126, to which further hydraulic loads each are connected via valves 128, 130. The one hydraulic load is a chute adjustment 132. The other load is the full drum closure 134 connected via the valve 130. In this variant, each load thus can be driven independently by its own electric motor, so that here the respective drive demand of each load can be satisfied selectively.

1. A mixer truck with a water system and a water pump for generating the required water pressure in the water system and with further energy consumers, wherein the water pump and/or at least one further load is driven by an electric motor.

2. The mixer truck according to claim 1, wherein the drive energy of the electric motor can be provided via the on-board power supply of the mixer truck.

3. The mixer truck according to claim 1, wherein the drive energy of the electric motor can be provided via an additionally mounted power source.

4. The mixer truck according to claim 3, wherein a generator serves as power source.

5. The mixer truck according to claim 3, wherein between electric motor and power source a controller is arranged.

6. The mixer truck according to claim 1, wherein as further load a high-pressure cleaner is provided.

7. The mixer truck according to claim 1, wherein as further load a linear drive is provided.

8. The mixer truck according to claim 1, wherein as further load a drum closure is provided.

9. The mixer truck according to claim 1, wherein as further load a chute adjustment is provided.

10. The mixer truck according to claim 1, wherein as further load an additive pump is provided.

11. The mixer truck according to claim 8, wherein via the electric motor a hydraulic drive is driven, which serves as drive of the load.

12. The mixer truck according to claim 1, wherein to each load a separate electric motor is associated as a drive.

13. The mixer truck according to claim 1, wherein to at least two loads one common electric motor is associated as a drive.

14. The mixer truck according to claim 4, wherein between electric motor and power source a controller is arranged.

15. The mixer truck according to claim 14, wherein as further load a high-pressure cleaner is provided.

16. The mixer truck according to claim 2, wherein as further load a high-pressure cleaner is provided.

17. The mixer truck according to claim 3, wherein as further load a high-pressure cleaner is provided.

18. The mixer truck according to claim 4, wherein as further load a high-pressure cleaner is provided.

19. The mixer truck according to claim 5, wherein as further load a high-pressure cleaner is provided.

20. The mixer truck according to claim 15, wherein as further load a linear drive is provided.
